(19) United States
(12) Patent Application Publication
(10) Pub. No.: US 2003/0154975 A1
(43) Pub. Date: Aug. 21, 2003

(54) Separation of sugars derived from a biomass

(76) Inventor: Gene E. Lightner, Federal Way, WA (US)

Correspondence Address: Gene E. Lightner, 706 S.W. 296th St., Federal Way, WA, 98023, US

(21) Appl. No.: 09/955,254

(22) Filed: Sep. 17, 2001

(51) Int. Cl. C13K 1/02

(52) U.S. Cl. 127/37

(57) ABSTRACT

By providing a biomass and an aqueous acidic solution to a hydrolysis vessel, hydrolysis within the hydrolysis vessel, forms sugars. The aqueous acidic solution, containing sugars, is withdrawn from the hydrolysis vessel and transferred to a phase forming vessel to form two phases; a sugar phase and an aqueous acidic solution phase. The sugar phase, upon withdrawing from the phase forming vessel, is subjected to additional processing outside the hydrolysis vessel. Residue, containing lignins remaining from the biomass, is withdrawn from the hydrolysis vessel and subjected to filtration resulting in a filtrate for recycle to the hydrolysis vessel and ffiltered residue for subsequent processing. Thereby, sugars are derived from a biomass, and residue, remaining from the biomass, is withdrawn from the hydrolysis vessel.

### BACKGROUND OF THE INVENTION

Present day interest in hydrolysis of biomass is to provide an alternative fuel source to avoid dependence on unreliable imported petroleum crude oil for liquid fuels. Cellulose and hemicellulose within a biomass may be converted to sugars of glucose and pentose sugars.

A means of removal of concentrated sulfuric acid from the acid hydrolysis of a biomass to produce sugars is described by Gaddy, et al, in U.S. Pat. No. 4,608,245, wherein a high molecular weight alcohol is employed to dissolve sulfuric acid from a hydrolysate to produce an aqueous solution containing sugars. Division of alcohol containing sulfuric acid is achieved by distillation.

A single step method of converting lignocellulosic materials employing concentrated sulfuric acid to produce sugars is contributed by Clausen, et al, in U.S. Pat. No. 5,188,673, The resulting hydrolysate is then separated from the reaction.

A method is presented by Lightner within U.S. Pat. No. 6,007,636, to recycle an acidic liquor employed for hydrolysis of a biomass to form an hydrolysate. This method is achieved with a solvent forming a precipitate of sugars within the hydrolysate. The precipitate is separated from the bydrolysate and the acidic liquor, upon substantially removing the solvent, the acidic liquor is recycled for additional hydrolysis. The precipitate contains lignins from the biomass.

The problem of separating sugars from a hydrolysate has not been practically solved.

It is an object of this invention to obviate the limitations or disadvantages of the prior art.

The present object of this invention is to react biomass within a hydrolysis vessel to form sugars within a hydrolysate and withdraw the hydrolysate, containing sugars, from the hydrolysis vessel.

A distinct object of this invention is to transfer hydrolysate to a phase forming vessel to form two phases; a sugar phase and an aqueous hydrolysate containing sugars. Another object of this invention is to remove the sugar phase from the phase forming vessel.

A further object of this invention is to recycle the phase of aqueous hydrolysate containing sugars to the hydrolysis vessel.

A direct object of this invention is to withdraw solids, containing lignins by hydrolysis of a biomass, from the hydrolysate within the hydrolysis vessel.

A supplementary object of this invention is fermentation of the sugars to produce ethanol. With the above and other objects in view, this invention relates to the novel features and alternatives and combinations presently described in the brief description of the invention.

### PRINCIPLES APPLIED BY THE INVENTION

The principles applied herein employ concentrated acid for hydrolysis of a biomass. Typical dry biomass composition is: lignin 25%, hemicellulose 25%, amorphous cellulose 10%, and crystalline cellulose 40%, thus biomass contains cellulose and hemicellulose. Biomass is often selected from the group which include wood, paper and lignocellulose materials including an individual or a combination of these thereof Sugars derived from a biomass include glucose and pentose sugars.

Prieto, et. al. in a report entitled “Concentrated Acid Hydrolysis With Acid Recovery,” reported on pages A-86-A95 within Biochemical/Alcohol Fuels Program: Annual Report, FY 1987. This disclosure employs 75% sulfuric acid at 30° C. to 57° C., to convert cellulose to sugars with approximately complete conversion to sugars. The deduction is made that hemicellulose within a biomass is also converted by hydrolysis with a concentrated acid to form pentose sugars. Considerable effort has been expended to remove sulfuric acid from a hydrolysate containing sugars, for example, extraction of sulfuric acid with a high boiling solvent followed by extraction with a low boiling solvent of the high boiling solvent then employs distillation to achieved recovery of solvents and sulfiric acid, as revealed on page A-91 and A-92, op. cit.

Solubility of glucose in aqueous sulfuric acid is the subject of “PROCESS FOR PRODUCTION OF SOLID GLUCOSE”, taught by Lightner, within U.S. Pat. No. 5,868,851, in which glucose is rendered insoluble by concentration of a hydrolysate containing glucose. The concentrated hydrolysate is employed at room temperature to form two phases; one of glucose and one of concentrated sulfuric acid. The two phases are separated to form solid glucose and concentrated sulfuric acid for recycle. Not taught by Lightner, the concentrated hydrolysate can be subjected to cooling, to produce a phase of sugars and a phase of hydrolysate, of depleted sugars, for recycle.

For additional information, Review Biochemical/Alcohol Fuels Program: Annual Report, November 1988.

### BRIEF DESCRIPTION OF THE INVENTION

The present invention in its broadest aspect, comprises a method to remove sugars from a hydrolysate, containing sugars, transferred from a hydrolysis vessel. Biomass and concentrated acid supplied to the hydrolysis vessel, will, by subjecting biomass to hydrolysis, form a hydrolysate containing sugars. Upon transferring the hydrolysate from the vessel, the hydrolysate is subjected to a phase forming vessel to form two phases; one phase of sugars and one phase of concentrated acid. In the preferred method, the transferred hydrolysate is cooled to form two phases, as earlier defined. The phase containing sugars is separated from the hydrolysate of concentrated acid and dissolved sugars, not separated. The separated sugar phase is subjected to additional processing and the phase of concentrated acid is recycled to the hydrolysis vessel. Residue containing lignins from hydrolysis of a biomass is subjected to filtration to produce a filtrate. The filtrate is recycled to the hydrolysis vessel. The filtered residue is extracted by water to produce extracted residue as a fuel and an extractate subject to additional treatment.

Characteristics of the invention include;

By providing the hydrolysis vessel with a biomass and concentrated acid, a hydrolysate of concentrated acid and sugars is formed.

Removing sugars from the hydrolysate is accomplished by forming two phases within a phase forming vessel.

The phase of concentrated acid is recycled to the hydrolysis vessel for additional hydrolysis of a biomass.

The hydrolysis vessel is established at a predetermined temperature of about 30° C. to about 45° C. and maintained at substantially isothermal conditions

Sugars of glucose and pentose sugars are customarily subjected to fermentation for production of ethanol.

Residue from hydrolysis of a biomass is filtered for producing filtered residue and a filtrate for recycle to the hydrolysis vessel.

### BRIEF DESCRIPTION OF THE DRAWINGS

The features that are considered characteristic of this invention are set forth in the appended claims. This invention, however, both as to its origination and method of operations as well as additional advantages will best be understood from the following description when read in conjunction with the accompanying drawings in which:

FIG. 1 is a flow sheet denoting the invention as set forth in the appended claims.

FIG. 2 is a flow sheet denoting a method to neutralize a sugar solution.

FIG. 3 is a flow sheet denoting a method to neutralize an extractate from filtered residue resulting from hydrolysis of a biomass.

### DETAILED DESCRIPTION OF THE PREFERRED EMBODIMENT

In the preferred embodiment of the present invention, sugars derived from a biomass, contained in a hydrolysate, are separated from the hydrolysate as an insoluble phase to produce sugars and a hydrolysate for recycle. Predetermined operating level of temperature range within the biomass hydrolysis method, is about 30° C. to about 45° C.

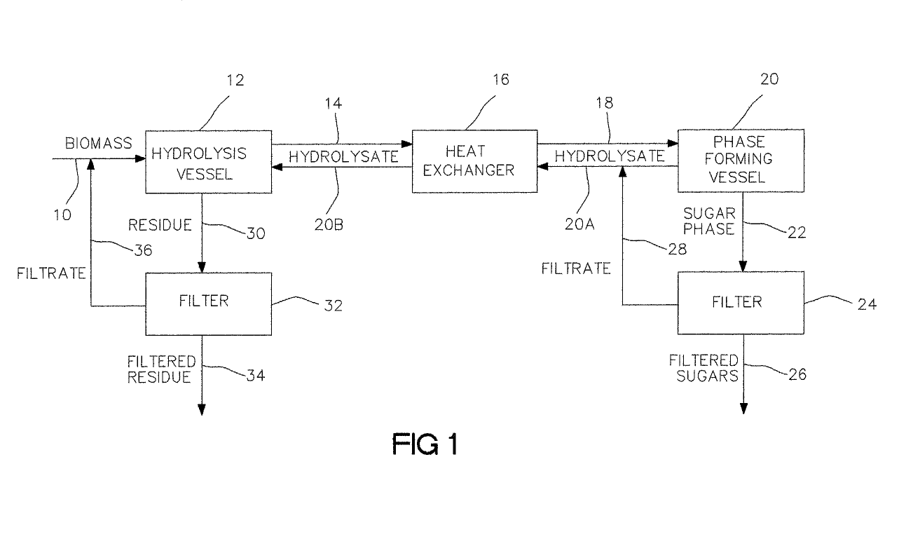

The flow diagram of FIG. 1 illustrates the general preferred embodiment of the present invention. In the diagram, rectangles represent stages, operations or functions of the present invention and not necessarily separate components. Arrows indicate direction of flow of material in the method

Referring to FIG. 1, biomass 10 and a hydrolysate 20B, containing an aqueous acidic solution, is conveyed to a hydrolysis vessel 12 and produces a hydrolysate 14 containing sugars derived from a biomass. The hydrolysate 14, containing sugars, is subjected to cooling within heat exchanger stage 16, and is conveyed to a phase forming vessel 20 to form two phases; a sugar phase 22, withdrawn from the phase forming vessel 20, and a hydrolysate phase containing an aqueous acidic solution 20A is also withdrawn from the phase forming vessel 20. The sugars phase 22 is transferred to a filter stage 24 to produce filtered sugars 26 and a filtrate 28 to be combined with the hydrolysate phase 20A The combination is conveyed to the heat exchanger stage 16, and then recycled to the hydrolysis vessel 12. Residue remaining from hydrolysis of a biomass, containing lignins, is withdrawn from the hydrolysis vessel 12 and subjected to filtering by filter stage 32 to provide filtered residue 34 and filtrate 36 to be recycled to hydrolysis vessel 12.

The method described in FIG. 1 employs hydrolysate 20B, containing an aqueous acidic solution, to hydrolyize the biomass 10 to derive sugars from a biomass 10. Sugars, capable of fermentation to produce ethanol and carbon dioxide, consist of the group which include glucose and pentose sugars including an individual or a combination thereof.

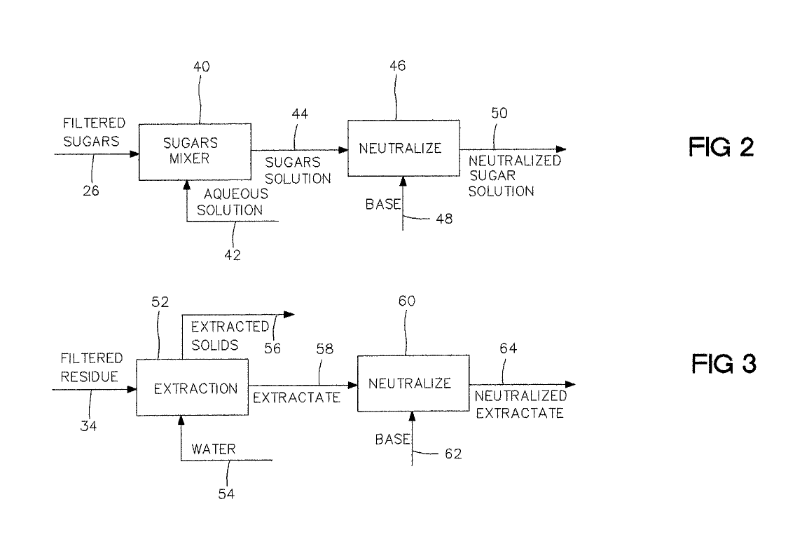

Referring to FIG. 2, filtered sugars 26 is added to sugars mixer stage 40 and mixed with aqueous solution 42 to form a sugars solution 44 and then transmitted to neutralize stage 46 and neutralized by a base 48 to form a neutralized sugar solution 50. Base 48, employed to neutralize the solution, is customarily ammonia or calcium carbonate. If the neutralized sugar solution 50 contains solids, a filter stage may be employed to separate solids from the neutralized sugar solution 50. Aqueous solution 42 is commonly a fermentation broth.

Referring to FIG. 3, filtered residue 34 is extracted by water 54 within extraction stage 52 to result in an extractate 58 and an extracted residue 56. The extractate 58 is transmitted to neutralize stage 46 and neutralized by a base 62 to form neutralized extractate 64.

The following examples are set forth to illustrate more clearly the principles and practice of the present invention

### EXAMPLE 1

### Part A

Ten grams of glucose is added to 100 grams of 70% sulfuric acid in a glass beaker to form a mixture. At about room temperature, the mixture is stirred by a glass rod to dissolve the glucose in 70% sulfuric acid to form a liquefied solution.

### Part B

The liquefied solution, in the glass beaker, is subjected to cooling in an ice bath to produce a temperature of about 0° C. After a short time the liquefied solution formed two phases, recognized as a glucose phase and a phase of 70% sulfuric acid saturated with glucose.

### EXAMPLE 2

Twenty grams of glucose is added to 100 grams of 70% sulfuric acid in a glass beaker to form a mixture. At about room temperature of about 20° C., the mixture is stirred by a glass rod in a futile attempt to dissolve the glucose in 70% sulfuric acid. After a prolonged time, the glucose did not

[symbol]

What is claimed is:

1. A method for separating sugars from a biomass hydrolyzed by an aqueous acidic solution which comprises:
providing a hydrolysis vessel for hydrolysis of a biomass, and
providing a supply of said biomass to said hydrolysis vessel, and
providing a supply of said aqueous acidic solution to said hydrolysis vessel, and
providing a phase forming vessel, and
subjecting said biomass, contained within said hydrolysis vessel, to hydrolysis by said aqueous acidic solution to form a hydrolysate containing sugars, and
withdrawing said hydrolysate from said hydrolysis vessel, and
transferring said hydrolysate to said phase forming vessel to form two phases; a sugar phase and an aqueous acidic solution phase, and
separating said sugar phase from said phase forming vessel, and
separating said aqueous acidic solution phase, from said phase forming vessel, for subsequent recycle to said hydrolysis vessel, and
withdrawing residue, remaining from hydrolysis of said biomass, containing lignins, from the hydrolysis vessel, thereby hydrolysis of a biomass forms a hydrolysate containing sugars and substantially separating the sugars from the hydrolysate and withdrawing residue remaining from hydrolysis of the biomass from the hydrolysis vessel and the hydrolysate, with sugars substantially removed, will provide recycled aqueous acidic solution to the hydrolysis vessel.

2. The method of claim 1 wherein said hydrolysis vessel is established at a predetermined temperature of about 30° C. to about 45° C. and maintained at substantially isothermal conditions.

3. The method of claim 1 wherein said phase forming vessel is established at a predetermined temperature of about 0° C. and maintained at substantially isothermal conditions.

4. The method of claim 1 wherein said biomass is selected from the group which include wood, paper and lignocellulose materials including an individual or a combination of these thereof

5. The method of claim 1 wherein said sugars consist of the group which include glucose and pentose sugars including an individual or a combination thereof

6. The method of claim 1 wherein said sugars are subjected to fermentation to produce ethanol.

7. The method of claim 1 wherein said hydrolysate, withdrawn from said hydrolysis vessel, is subjected to a temperature of about 0° C.

8. The method of claim 1 wherein said hydrolysate is subjected to cooling, to produce a phase of sugars and a phase of said aqueous acidic solution.

9. The method of claim 1 wherein said residue, containing lignins, is filtered to produce filtered residue and a filtrate for recycle to the hydrolysis vessel.

10. The method of claim 8 wherein said filtered residue is subjected to extraction by water to produce water extracted residue and an aqueous extractate.

11. The method of claim 1 wherein said sugars is dissolved by an aqueous solution.

12. The method of claim 10 wherein said aqueous solution is supplied from a fermentation broth.

13. The method of claim 10 wherein said aqueous solution containing an acid is neutralized by a base or calcium carbonate.

14. The method of claim 10 wherein said aqueous solution containing an acid is neutralized by ammonia.

15. The method of claim 1 wherein said residue is subjected to filtering to produce filtered residue and a filtrate for recycle to said hydrolysis vessel.

16. The method of claim 14 wherein said filtered residue is subjected to extraction with water to form extracted residue and an extractate.

17. The method of claim 15 wherein said extractate containing an acid is neutralized by a base.

18. The method of claim 1 wherein said aqueous acidic solution contains sugars.

19. The method of claim 1 wherein said aqueous acidic solution contains about 70% sulfuric acid.
